(19) United States
(12) Patent Application Publication
(10) Pub. No.: US 2009/0223126 A1
(43) Pub. Date: Sep. 10, 2009

(54) VERTICAL PLANT SUPPORTING SYSTEM

(76) Inventors: Gregory Garner, Brantford (CA); Keith Ardron, Guelph (CA); Neil Sisler, Brantford (CA)

Correspondence Address: BERESKIN AND PARR LLP/S.E.N.C.R.L., s.r.l., 40 KING STREET WEST, BOX 401, TORONTO, ON, M5H 3Y2, CA

(21) Appl. No.: 12/204,024

(22) Filed: Sep. 4, 2008

Related U.S. Application Data
(63) Continuation of application No. PCT/CA2007/000357, filed on Mar. 6, 2007.
(60) Provisional application No. 60/778,842, filed on Mar. 6, 2006.

(51) Int. Cl. A01G 9/02; A01G 25/00

(52) U.S. Cl. 47/66.7; 47/82; 47/65.5

(57) ABSTRACT

A vertical plant support includes a wall having a panel and an anchor layer, and a matrix of tubes being connected to the wall. The anchor layer is located intermediate the panel and the matrix of tubes. The panel can be liquid impermeable and the anchor layer can be liquid permeable.

This application is a continuation of PCT/CA2007/00357 filed on Mar. 6, 2007 which claims the benefit of U.S. Provisional Application No. 60/778,842 filed Mar. 6, 2006. The disclosures of PCT/CA2007/000357 and 60/778,842 are incorporated herein, in their entirety, by this reference to them

### FIELD OF THE INVENTION

The present invention relates to the field of vertical plant supports, and more particularly to apparatus and methods for living walls.

### BACKGROUND OF THE INVENTION

A living wall is a vertical garden. Vertical gardens can be mounted against a wall, or can be used independently as a privacy barrier. A single or multi-sided vertical garden can also be used as a freestanding architectural feature. Living walls may be located both indoors and out, and offer many functional, environmental and aesthetic benefits.

In exterior applications, living walls provide a form of urban agriculture or urban gardening, providing good use of otherwise unutilized vertical surface areas. They may be built as a work of art for their own sake, or they may be incorporated into roadside advertising or other commercial display applications. Functionally, a living wall can clad an existing structural wall thereby extending the lifespan of traditional exterior wall materials and reducing heating and cooling energy costs.

Indoors, living walls can provide a pleasing natural feature for building occupants. They can also improve the quality of re-circulated air with the photosynthetic production of Oxygen and by providing bacteria on the roots of the plants that metabolize air impurities such as volatile organic compounds. So called active walls may be joined to a building's air circulation system where fans blow air through the wall and then re-circulate the air throughout the building. Some active walls are kept behind glass to create more predictable airflow effects. Inactive walls have no mechanized air circulation. Instead, they are kept open to promote as much free air circulation as possible.

Living walls, both indoor and outdoor, also provide a means for water reuse, at least as utility water. The plants of a living wall may purify slightly polluted water (such as greywater) by digesting the dissolved nutrients, with Bacteria mineralizing the organic components to make them available to the plants.

Typically, a living wall will be either freestanding or installed directly on an existing wall surface. Many systems use a lightweight mineral substrate of different sizes with pockets of growing medium, alternative rainwater, drip or mist watering systems, and planting selected for the particular microclimatic conditions at its installed location.

The vegetation of living walls is typically grown from seed after the other components of the living wall are installed. This growing period results in increased maintenance costs, loss of growth medium from wind erosion in exterior applications and other natural forces, and delays the realization of benefits from the living wall. Living walls installed in this fashion are also typically permanent or semi-permanent fixtures and, as such, render repairs to the underlying wall difficult and expensive.

In cases where living walls are installed on existing structural walls, significant alterations may be required to the existing wall surface to accommodate a permanent or semi-permanent installation. Existing cladding may not be capable of suitable attachment, or sustaining long-term direct contact with water and growth media. Permanent and semi-permanent installations are also typically static in their design, with the structure and site-grown plant selection being established at the time of installation. Any desired structural or planting changes, for either functional, commercial or aesthetic reasons, would require disrupting or replacing the established living wall, thereby incurring more maintenance costs and delays in benefit from the new living wall design.

Thus, there is a need for an improved vertical plant support for use in a living wall application that overcomes some or all of the disadvantages evident in current living wall designs.

### BRIEF DESCRIPTION OF THE DRAWINGS

In the accompanying drawings,

FIG. 1 illustrates a front isometric view of a vertical plant supporting system in accordance with the present invention;

FIG. 2 is a back isometric view of the vertical plant supporting system of FIG. 1;

FIG. 3 is a side view of the vertical plant supporting system of FIG. 1;

FIG. 4 is a front view of the vertical plant supporting system of FIG. 1;

FIG. 5 is a back view of the vertical plant supporting system of FIG. 1;

FIG. 6 is a top view of the vertical plant supporting system of FIG. 1; and

FIG. 7 is a bottom view of the vertical plant supporting system of FIG. 1.

FIG. 8 is a perspective view of an alternate embodiment of the vertical plant support;

FIG. 9 is a perspective view of an alternate embodiment of the vertical plant support;

FIG. 10 is a perspective view of an alternate embodiment of the vertical plant support;

FIG. 11 is a perspective view of a living wall comprising a plurality of vertical plant supports;

FIG. 12 is a perspective and detail illustration of an example means of connecting adjacent vertical plant supports for use in a living wall application;

FIG. 13 is a perspective view and detail of an example method of mounting vertical plant supports to a vertical surface;

FIG. 14 is perspective view and detail of other methods of hanging a vertical plant support;

FIG. 15 is a rear perspective view of a vertical plant support with one form of irrigation;

FIG. 16 is a partial side view of a vertical plant support and trough;

FIG. 17 is a side view of a vertical plant support with misting irrigation;

FIG. 18 is another embodiment of a vertical plant support for use in cleaning greywater;

FIG. 19 is a partial perspective view of a vertical plan support with additional rooting holes;

FIG. 20 is a side view of another irrigation system comprising a pump to recycle liquid;

FIG. 21 is a collection of views of another embodiment of a vertical plant support;

FIG. 22 is a collection of views of an alternate embodiment of a vertical plant support of FIG. 21; and

FIG. 23 are isometric views of the vertical plant support of FIG. 21; and

FIG. 24 is a photograph of a vertical plant support with vegetation supported therein.

### DETAILED DESCRIPTION OF THE INVENTION

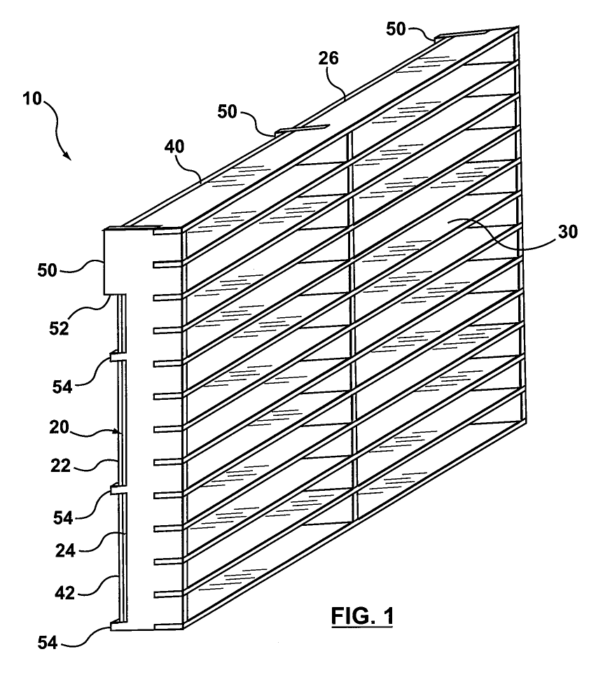

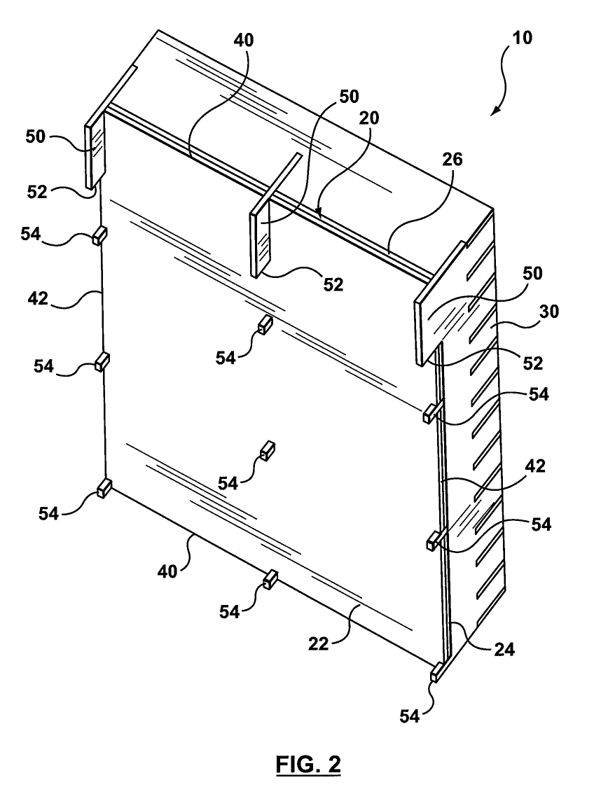

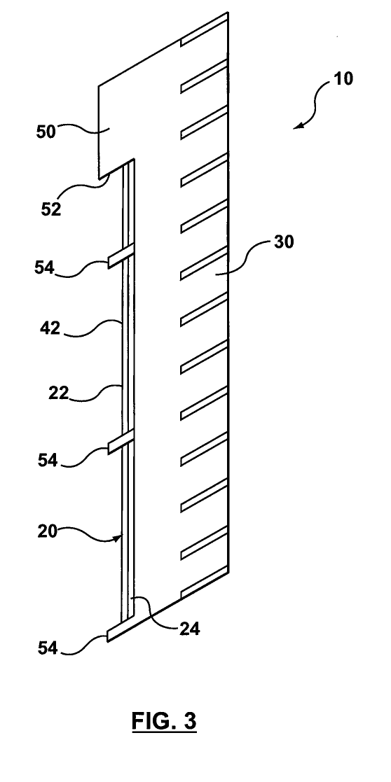

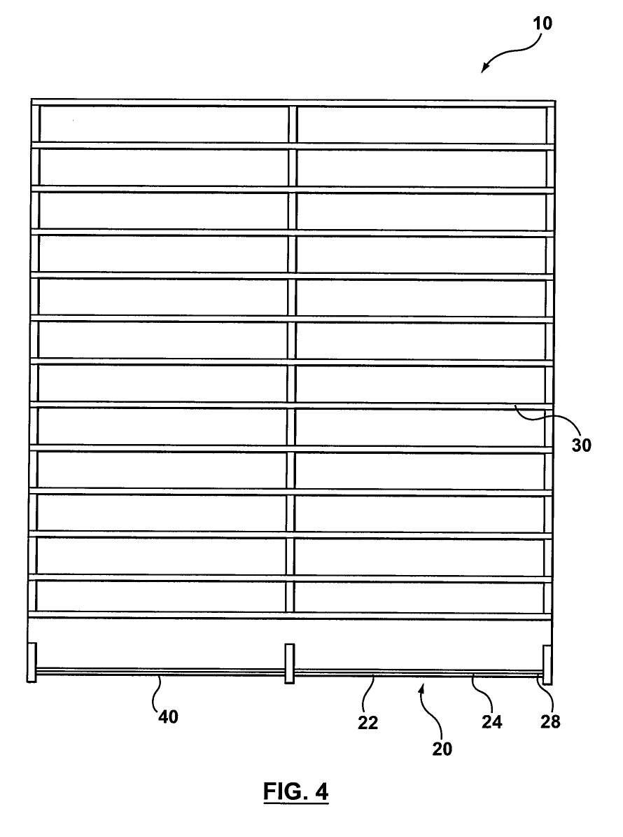

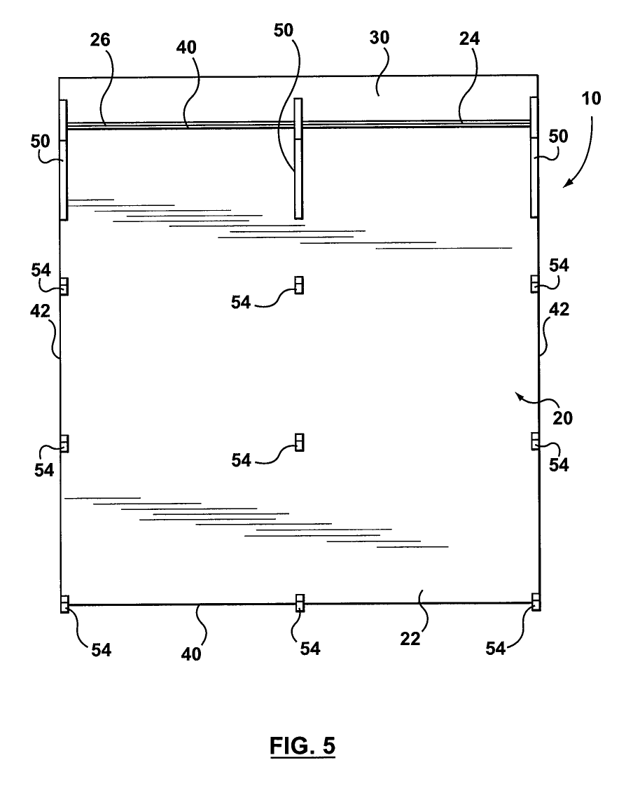

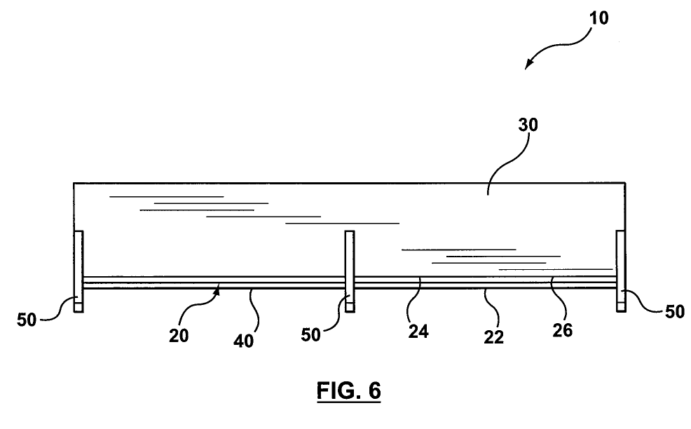

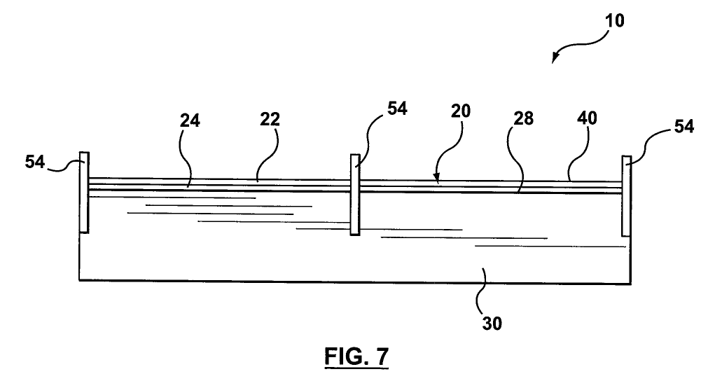

Referring to FIGS. 1 to 7, there is generally illustrated one embodiment of a vertical plant support 10 in accordance with the present invention having a wall 20 and a matrix of tubes 30. Wall 20 comprises a panel 22 and an anchor layer 24 oriented so that the anchor layer 24 is positioned intermediate the panel 22 and the matrix of tubes 30. The matrix of tubes 30 can be arranged as any regular or irregular array or arrangement of tubes. Each tube is open at the front portion to provide an aperture through which plants grow, and at the rear portion adjacent the anchor layer 24 so that the plant roots may grow into the anchor layer 24. Preferably, anchor layer 24 is exposed along an upper edge 26 and a lower edge 28 while intermediate the panel 22 and matrix of tubes 30. Also preferably, vertical plant support 10 is provided with at least one means for attaching the vertical plant support 10 to a vertical structure or support. In the illustrated embodiment, an advantageous hanging element 50 is shown connected to the upper portion of the wall 20 and extending rearward therefrom. Hanging element 50 defines a hanging surface 52 adapted to mate with a cooperating portion of a vertical structure or support (not shown). Vertical plant support 10 may also include one or more feet 54 sized to space the vertical plant support 10 from its supporting structure. Feet 54 can be sized to project rearward a distance similar to the hanging supports 50, or they may be longer or shorter thereby causing to vertical plant support 10 to deviate from a vertical orientation.

Vertical plant support 10 may be manufactured from several individual components that are fastened together by welding, adhesives or other bonding or fastening methods, or it may be moulded to form one or more pieces that are then connected together.

In the embodiment depicted in FIGS. 1 to 7, wall 20 is shown to be generally rectangular, and the volume of the matrix of tubes 30 is defined by a parallelepiped. With consideration of the discussion below, it will be apparent to one skilled in the art, that the perimeter shape and volume defined by vertical plant support 10 may be modified and still be within the scope of the invention disclosed herein, all of which is intended to be included in this description.

Typically, anchor layer 24 is a porous sheet of regular or irregular three-dimensional mesh or screen. For example, anchor layer 24 may be a sheet of intertwined fibers, wire, or coated wire. Anchor layer 24 can be made of any suitable material including, but not limited to, plastics such as such as polyester, polyethylene, polyvinyl chloride, and polypropylene, wires made of metals such as steel and copper, organic materials such as hemp, rockwool, wood fibers, and coconut fibers, and combinations thereof. It has been found particularly advantageous to use a combination of natural and synthetic fibres. Natural fibres have a natural wicking ability that helps transport water add nutrients to the plants. Synthetic fibres offer a stable, long-lasting structure to support root growth.

Panel 22 and the matrix of tunes 30 can be made of any suitable material including, but not limited to, wood, metal, and plastics such as polyester, polyethylene, polyvinyl chloride, polypropylene, and combinations thereof.

In the embodiment depicted in FIGS. 1 to 7, panel 22 is square having first sides 40 approximately two feet in length and second sides 42 also approximately two feet in length. In this embodiment, the matrix of tubes 30 are arranged to define 2 columns and 12 rows of cavities adapted to accept plantings. In this example, each tube will have an open end that measures approximately 2 inches by 12 inches, and have a depth of approximately 4 inches. Anchor layer 24 may have any dimensions suitable for a particular embodiment. In one embodiment, anchor layer 24 is between 0.125 and 1 inch thick. It will be appreciated by one skilled in the art that the precise dimensions of the vertical plant support 10 will be governed by many factors, including the location of the installation, the types of plants grown, the weight-bearing capacity of any underlying support wall. Modifications of this nature are intended to be included within the scope of this disclosure.

A further aspect illustrated in FIGS. 1 to 7 in respect to the vertical plant support 10 is the acute angle at which each tube in the matrix of tubes 30 extends outwardly from the anchor layer 24. In the depicted embodiment, each tube forms an approximately 60-degree angle with the anchor layer 24. Angles greater or less than 60 degrees may be employed as determined by the circumstances of the installation. The purpose of the angle is to facilitate the retention of water and growth media that may be added to the closed cavity defined by each tube in the matrix of tubes 30.

In use, anchor layer 24 provides a means for supporting the growth of vegetation. Typically, the roots of vegetation propagate into, and become entangled in, anchor layer 24. In this way, anchor layer 24 provides physical support to the vegetation. Anchor layer 24 also retains water and nutrients that are supplied to it and in turn supplies the water and nutrients to the vegetation. Anchor layer 24 may also be impregnated with a growth medium or growth medium may be added to the cavity defined by each tube in the matrix of tubes 30. Growth medium may be chosen from a variety of materials. For example, many soils, sands, and gravels may be used. As well, clay, gravel, fertilizer, peat, compost, super-absorbent polymers, and combinations thereof may be used in other embodiments, for example.

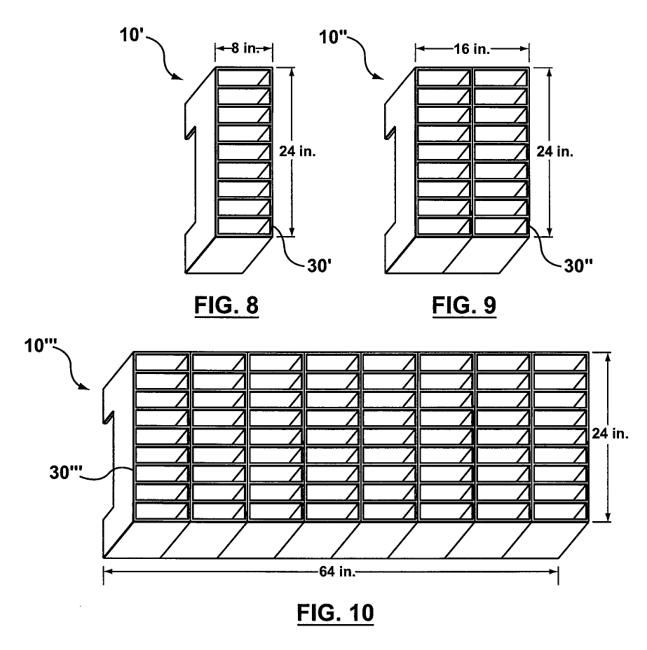

For greater certainty, examples of alternate embodiments of the vertical plant support are shown in FIGS. 8 to 10. FIG. 8 shows vertical plant support 10′ having a matrix of tubes 30′ arranged as a single array of one column and 8 rows of tubes, with the open end of each tube measuring approximately 8 inches by 3 inches. FIG. 9 shows a vertical plant support 10″ similar to vertical plant support 10 with two columns and 9 rows of tubes in the matrix 30″. Similarly, FIG. 10 shows an expanded vertical plant support 10′″ having a matrix of tubes arranged into 9 rows and 8 columns.

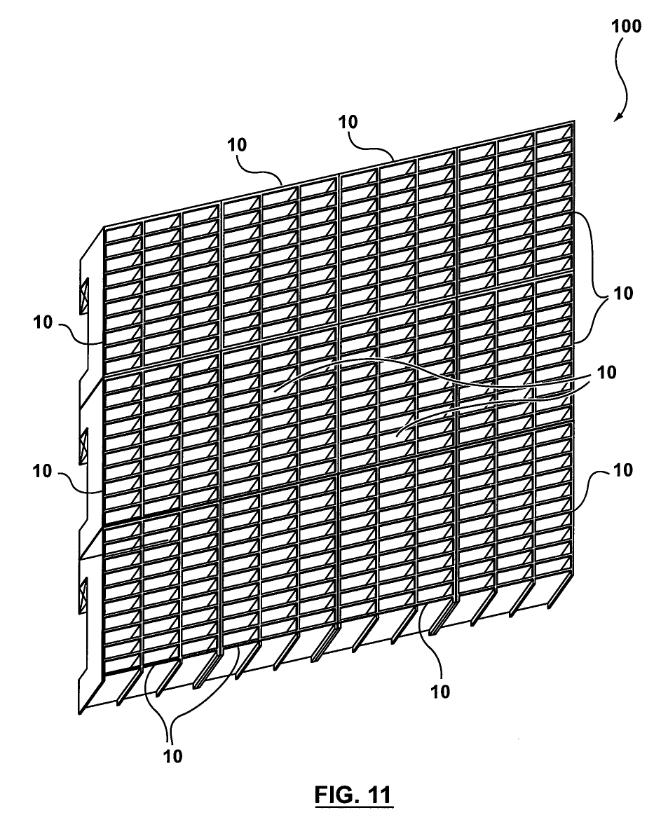

Referring now to FIG. 11, installations of a living wall 100 in accordance with the present invention may be accomplished by combining one or more individual vertical plant supports 10. In the illustrated example, 12 vertical plant supports 10 are arranged in a four-by-three grid. Preferably, vertical plant supports 10 are shaped so as to abut with adjacent vertical plant supports so that little or no gaps are present, thereby enhancing the appearance of the living wall 100.

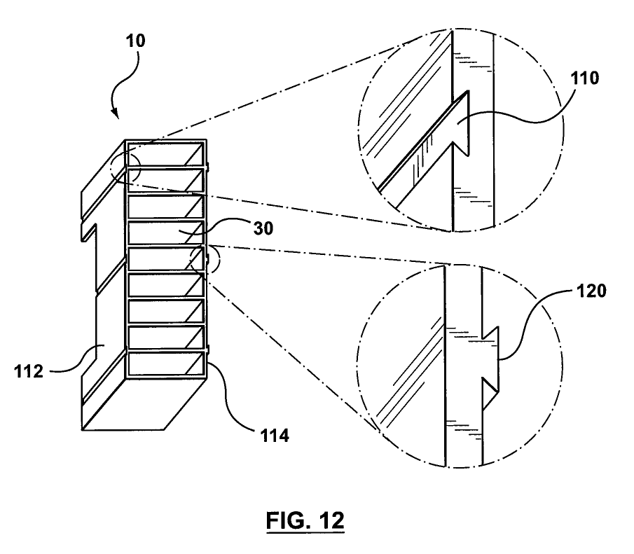

Referring to FIG. 12, vertical plant support may optionally be adapted to interconnect with adjacent vertical wall supports 10 in a living wall 100 application. Integral connectors may take on many different forms. FIG. 12 illustrates one such method, where at least one dovetail slot 110 is defined on an exterior surface 112 of the matrix of tubes 30. The opposite exterior surface of the matrix of tubes 30 contains a similar number of dovetail ribs 120 positioned so as to align with the correspondingly sized dovetail slots 110 of an adjacent vertical plant support 10.

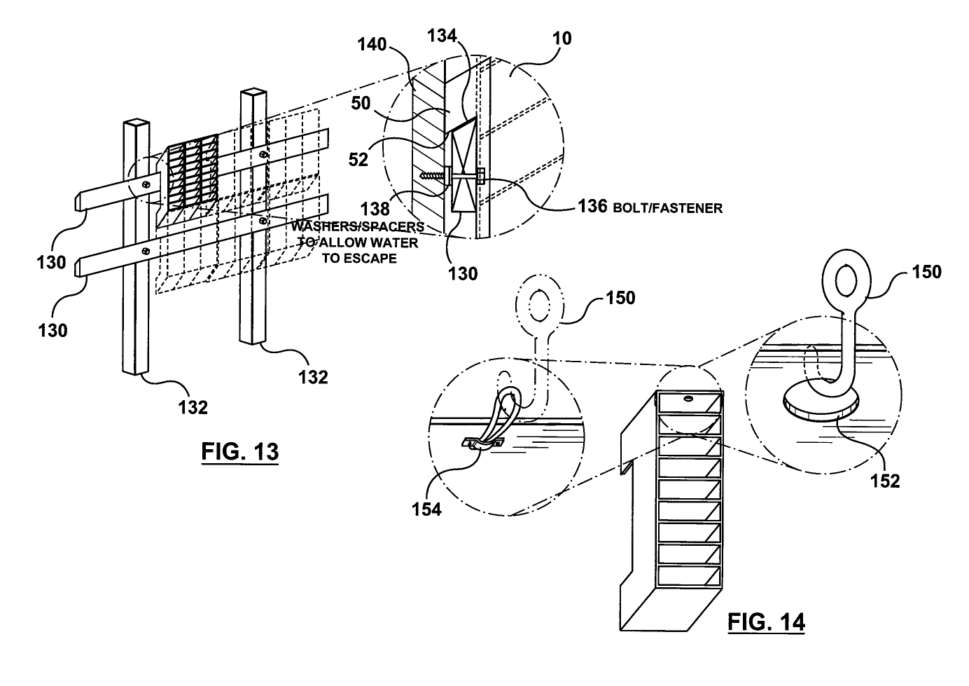

Individual vertical plant supports 10 can be located in indoor or outdoor environments, and may be connected to any number of different vertical support structures by numerous means within the skill of an ordinary worker. A first example is illustrated in FIG. 13, whereby one or more vertical plant supports can be hung from one or more beveled horizontal rails 130. Horizontal rails 130 may optionally be attached to vertical rails 132 to provide adequate clearance with the underlying support structure. The horizontal rails 130 may also be connected directly to the surface of a structural wall 140. The blow-up detail of FIG. 13 shows a side view of a vertical plant support 10 mounted on a horizontal rail 130. Horizontal rail 130 is advantageously configured to have a beveled top surface 134 that extends outwardly and upwardly with respect to the structural wall 140. Horizontal rails 130 may be connected to the structural wall 140 by many means commonly understood in the art. The illustrated embodiment shows bolt 142 and spacers 138 located intermediate the horizontal rail 130 and the structural wall 140 The beveled angle on the horizontal rail 130 is adapted to match the angle of the hanging surface 52 of the example hanging element 50.

Preferably, the angle of the matrix of tubes 30, the angle of the hanging surface 52, and the angle of the beveled upper surface of the horizontal are substantially equal with respect to the supporting structure such as structural wall 140. This allows an individual vertical plant support 10 that is a part of a larger living wall 100 installation, with adjacent vertical plant supports 10 abutting each other, to be slidably removed from living wall 100 for replacement with a new vertical plant support 10, or repair of the supporting structure such as the structural wall 140.

FIG. 14 illustrates yet another example of a means for attaching vertical plant support 10 to its support structure. One or more hooks 150 may be connected to a ceiling, bracket or other weight-bearing structure (not shown). One or more of the tubes in the matrix of tubes 30 may optionally define apertures 152 sized to accommodate hooks 150. Similarly, one or more of the tubes in the matrix of tubes 30 may optionally have a strap 154 connected thereto and of sufficient length to engage one or more hooks 150.

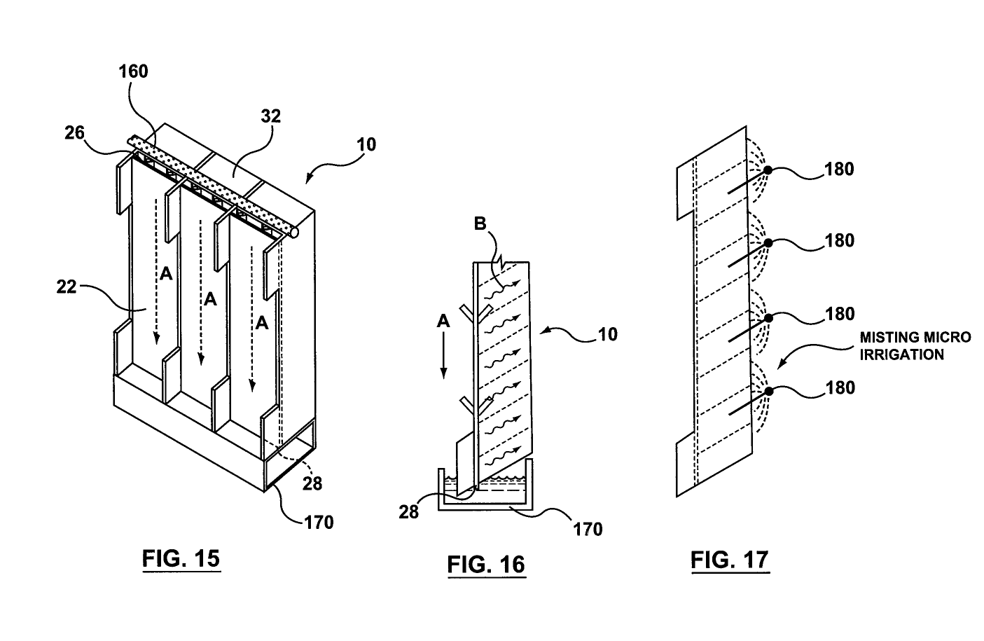

With reference to FIG. 15, there is shown an embodiment of an irrigation system for a vertical plant support 10. Water supply 160 is positioned along the upper surface of the matrix of tubes 30 and connected to a supply of water that may contain additional plant nutrients (not shown). The illustration shows water supply 160 as a soaker hose, but it will be appreciated that water supply 160 may include many other water distribution means such as drip irrigation or storm water runoff from a exterior roof. Preferable, water supply 160 is positioned so that the supplied water contacts the upper surface 32 of the matrix of tubes 30 at or above upper edge 26. Water and/or nutrients may then flow downward under the influence of gravity, either directly onto the upper edge 26 of porous anchor layer 24 or down the inclined upper surface 32 of the matrix of tubes 30. Preferably, water supply 160 delivers the water to the vertical plant support 10 substantially as a sheet so that the volume of water entering the anchor layer 24 at its upper edge 26 is substantially uniform. Optionally, panel 22 my be extended upwardly or an additional barrier (not shown) may be attached to the upper edge of panel 22 to ensure that water or nutrients do not flow down the rear exterior surface of the panel 22, possibly causing damage to any supporting structural surfaces. Water and nutrients then flow downward through anchor layer 24 in main flow direction A. Optionally, a trough 170 may be positioned adjacent lower edge 28 to collect any discharge of excess water.

When vertical plant supports 10 are hung as part of a living wall 100 and at least one vertical plant support is mounted above another, it has been found to be advantageous if the lower edge 28 of the anchor layer 24 is positioned adjacent the upper surface 32 so that water and/or nutrients that drain from the upper vertical wall support 10 flow downward on the upper surface in a manner similar to that described above. This positioning can be accomplished selectively sizing feet 54 or by any other means understood in the art.

FIG. 16 illustrates that in additional to the main flow direction A, water and nutrients are able to drawn in wicking direction B by plants, either through wicking action or by saturating growth media that may be located in the cavities defined by each tube in the matrix of tubes 30 (not shown). Optionally, FIG. 17 shows that mist irrigation systems may also be affixed to the front portion of the matrix of tubes, and arranges and operated as generally understood in the art.

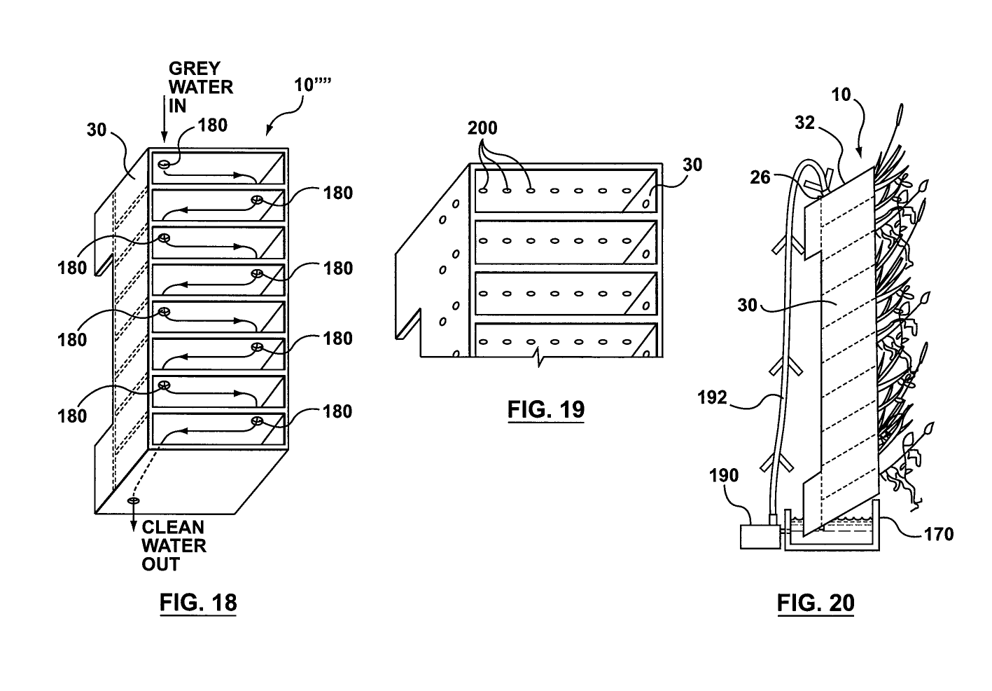

Referring to FIG. 18, there is shown an alternate embodiment of a vertical plant support 10″″ for cleaning grey water. Preferably, defined in the horizontal surfaces of each tube in the matrix of tubes 30 there are flow holes 180 defined, spaced apart so as to form a boustrophedonic course C for the flow of grey water downward through the matrix of tubes 30. In this embodiment, vertical plant support 10″″ may optionally contain one or more anchor layers 24 or other growth media as understood in the art.

Referring to FIG. 19, optionally, a plurality of rooting holes 200 may be defined in the horizontal or vertical surfaces of each of the tubes in the matrix of tubes 30 to allow roots to grow between adjacent tubes in the matrix of tubes 30.

FIG. 20 illustrates another optional irrigation system wherein a pump 190 may be connected in fluid connection with trough 170. The outlet of pump 190 is then connected to conduit 192 for delivering water to the upper surface 32 of the matrix of tubes 30, above the upper edge 26, thereby creating a loop that recycles at least a portion of the water and/or nutrients.

Vertical plant support 10 can be easily installed on-site without requiring significant or permanent modification to the support structure or wall. They may be hung from an existing structural wall or a support structure may be erected to support the vertical plant supports 10. This design feature advantageously allows each vertical plant support 10 to be populated with plants off-site and in controlled conditions such as a plant nursery, and then transported to the installation location. Typically, one of the major risks and expense to installing a vertical plant support 10 or larger living wall 100 installations is the growing of the plants in what are sometimes marginal growing conditions. By growing and establishing the plants in controlled conditions, they are thereby better able to adapt to their installed environment with increased chance for successful growth. This also reduces expenses related to tending to the plants during the growing phase. In this regard, the present invention also allows the vertical plant support 10 to be oriented horizontally while the plants are being established, which also facilitates the maintenance and increases the chances of successful growth during the initial phase.

This modularity also allows for individual vertical plant supports 10 to be exchanged as desired. Adjustments can therefore be made if the microclimate changes or if different plants are desired for a particular location. One is also able to incorporate designs in a living wall 100 application by choosing plants desirable texture or colour characteristics in adjacent vertical plant supports 10. The design can then be changed later if desired.

Optionally, vertical plant supports 10 may be used as part of a bio-filtration system. In this case, panel 22 would be gas permeable, thereby allowing air to be forced through the vertical plant support 10 by establishing a pressure differential between the front and rear of the vertical plant supports 10 to draw air through the structure, thereby removing impurities from the air.

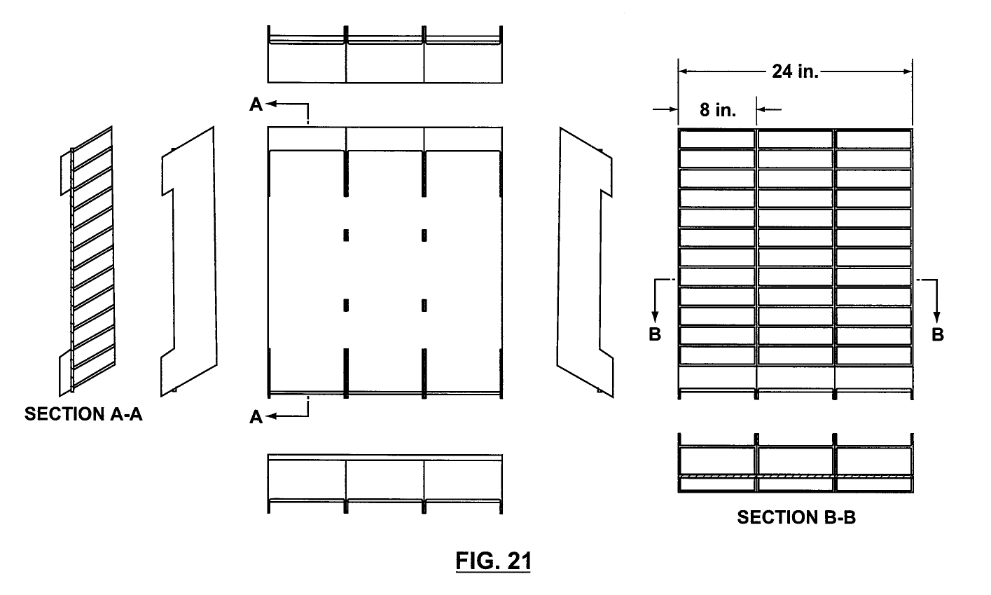

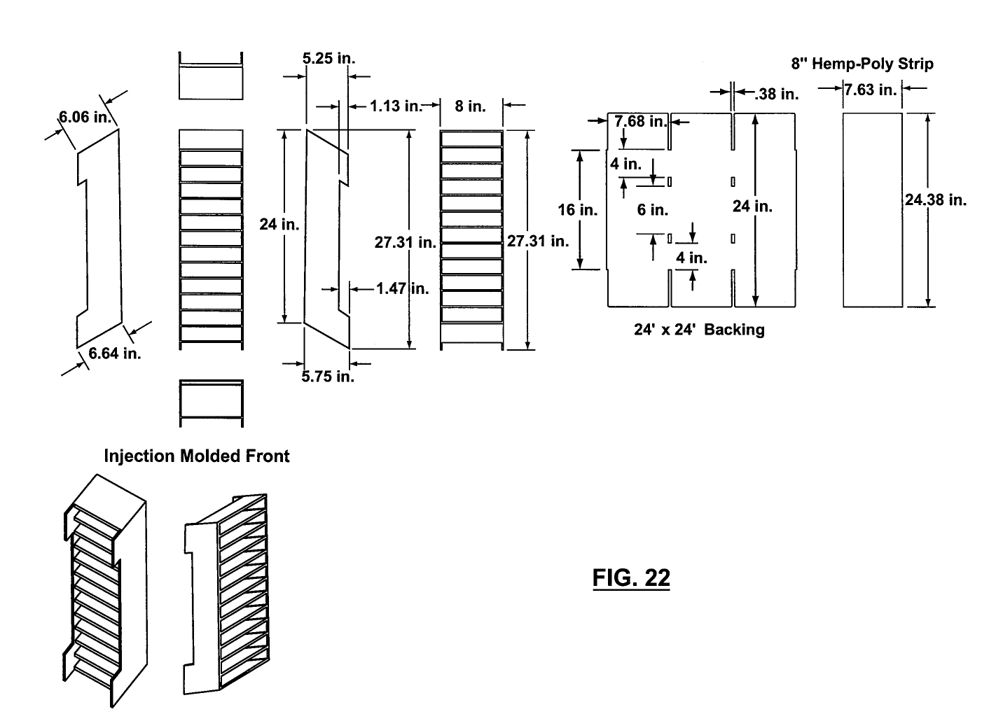

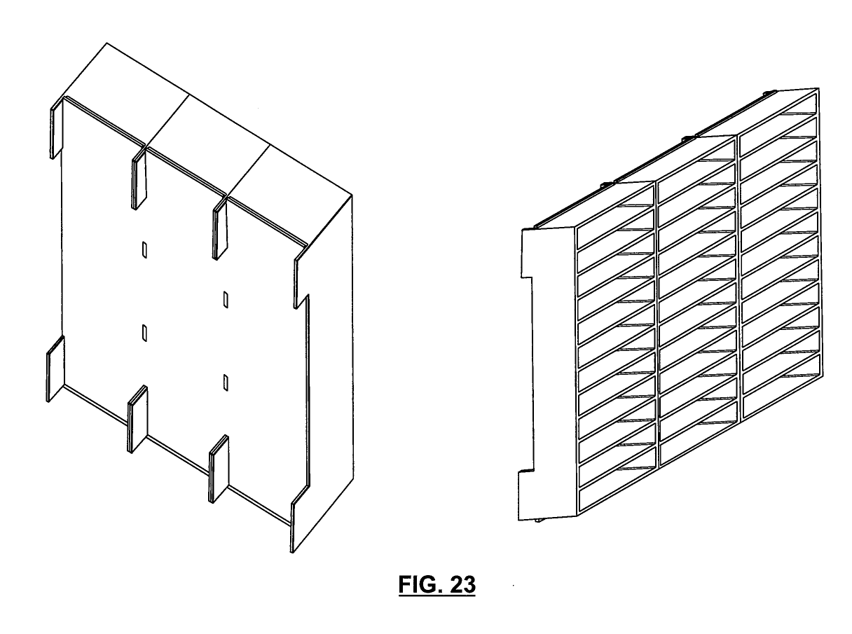

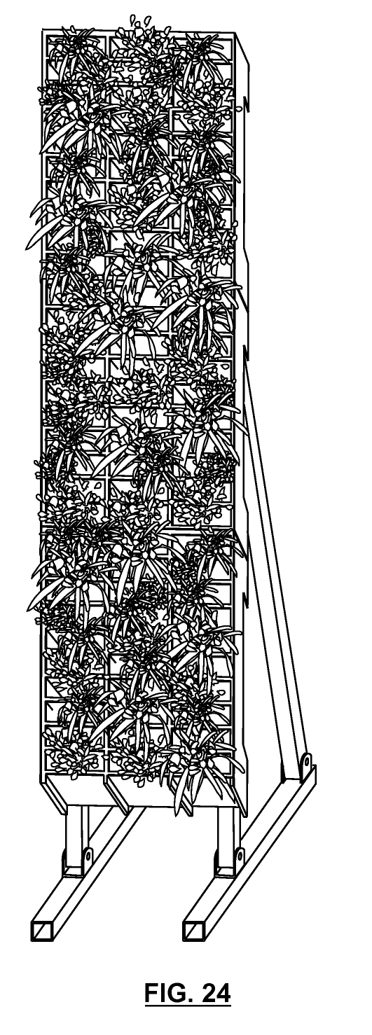

FIGS. 21 to 23 illustrate an alternate embodiment wherein the matrix of tubes 30 are manufactured using injection moulding, while panels 22 are stamped from sheets of suitable material.

While the invention has been described with reference to specific embodiments, one skilled in the art will appreciate that various other adaptations and modifications may be made to the method and apparatus of the present invention, and that all such modifications and adaptations are intended to be encompassed within the scope of the invention.

1. A vertical plant support comprising:
a) a wall, said wall comprising a panel and an anchor layer; and
b) a matrix of tubes, said matrix of tubes being connected to said wall,
wherein said anchor layer is located intermediate said panel and said matrix of tubes.

2. The vertical plant support of claim 1, wherein said panel is liquid impermeable.

3. The vertical plant support of claim 1, wherein said anchor layer is liquid permeable.

4. The vertical plant support of claim 3, wherein each tube in said matrix of tubes comprises a rear portion, at least part of said rear portion being adjacent said anchor layer, and wherein rear portions of adjacent tubes in said matrix of tubes are in fluid communication.

5. The vertical plant support of claim 3, further comprising a source of liquid for nurturing plants, said source of liquid being in liquid communication with said anchor layer

6. The vertical plant support of claim 1, wherein said matrix of tubes extend outward from the anchor layer at an acute angle.

7. The vertical plant support of claim 1, wherein said panel and said anchor layer are substantially coterminous.

8. A living wall comprising a plurality vertical plant supports, each of said vertical plant supports having a wall and a matrix of tubes, said wall comprising a panel and an anchor layer and said matrix of tubes being connected to said wall, wherein said anchor layer is located intermediate said panel and said matrix of tubes.

9. The living wall of claim 8, wherein the matrix of tubes of each said vertical plant support defines a perimeter, wherein at least a portion of said perimeter is connectable with at least a portion of the perimeter of an adjacent vertical plant support.

10. The living wall of claim 8, wherein the anchor layer of adjacent vertical plant supports are in liquid communication.

11. A method for installing a living wall comprising the step of:
a) providing at least one plant support having a wall and a matrix of tubes, said wall comprising a panel and an anchor layer and said matrix of tubes being connected to said wall, wherein and said anchor layer is located intermediate said panel and said matrix of tubes;
b) growing plants in the matrix of tubes of the at least one plant support while the plant support is in a generally horizontal position; and
c) erecting the at least one plant support in a generally vertical position.

12. A method for irrigating a living wall comprising the steps of:
a) providing at least one vertical plant support having a wall and a matrix of tubes, said wall comprising a panel and a liquid permeable anchor layer having an upper edge, wherein said matrix of tubes is connected to said wall and said anchor layer is located intermediate said panel and said matrix of tubes;
b) providing a source of liquid suitable for nurturing plants;
c) distributing said liquid along the upper edge of said anchor layer so that said liquid is substantially horizontally uniform as it propagates through said anchor layer under the influence of gravity.
